(19) United States
(12) Patent Application Publication
(10) Pub. No.: US 2018/0334921 A1
(43) Pub. Date: Nov. 22, 2018

(54) STATOR ARRANGEMENT

(71) Applicant: ROLLS-ROYCE plc, London (GB)

(72) Inventor: Piera CARUGNO, Derby (GB)

(73) Assignee: ROLLS-ROYCE plc, London (GB)

(21) Appl. No.: 15/983,555

(22) Filed: May 18, 2018

(30) Foreign Application Priority Data
May 19, 2017 (GB) 1708050.8

(51) Int. Cl. F01D 17/16

(52) U.S. Cl. CPC F01D 17/167; F05D 2220/32

(57) ABSTRACT

A stator arrangement for use in a gas turbine engine, the arrangement comprising an inner outlet guide wall having a central axis, the inner outlet guide wall comprising a first aerofoil extending radially relative to the central axis; the an inner outlet guide wall further comprising a second aerofoil extending radially relative to the central axis, the second aerofoil being relatively displaceable between a first position and a second position; the first aerofoil combining with the second aerofoil to form a combined aerofoil when the second aerofoil is in the first position, and separating to form two or more aerofoils when the second aerofoil is relatively displaced, in use, from the first position towards the second position; wherein one or more of a profile, shape or configuration of the second aerofoil, when in the second position, are substantially identical to that of the first aerofoil.

### CROSS-REFERENCE TO RELATED APPLICATIONS

This application is based upon and claims the benefit of priority from British Patent Application No. GB 1708050.8, filed on 19 Mar. 2017, the entire contents of which are hereby incorporated by reference.

### BACKGROUND

### Technical Field

The present disclosure concerns a stator arrangement. In particular, the present disclosure concerns a stator arrangement for use in a gas turbine engine.

### Description of the Related Art

During operation of a gas turbine engine, it is common for an amount of noise to be produced. Noise may be produced in several areas of a gas turbine engine including, for example, one or more of the fan, compressor, combustor, and turbine sections. In particular, the compressor system may comprise a low pressure (LP) system. The LP system may comprise a rotor and a number of vanes, known singularly as an outlet guide vane (OGV) or collectively as outlet guide vanes (OGVs). OGVs are commonly located at an outlet of the fan and within a bypass duct. In this way, the OGVs can direct air travelling within the bypass duct in a required direction of airflow.

Noise generated within the LP system can be broadly divided in two parts: tone noise and broadband noise. Gas turbine engines are commonly affected by tone noise and broadband noise. Tone noise is a steady and deterministic phenomenon that strongly depends on the ratio between the number of fan blades and the number of OGVs.

Conversely, broadband noise has an unsteady and chaotic character, mainly caused by the turbulent wakes shredded at the rotor trailing edges impinging on the leading edges of the OGVs. Because of their characters, tone noise is a phenomenon that is concentrated at specific frequencies, namely the blade passing frequency and its harmonics. Broadband noise expresses itself as a “carpet” of noise affecting all frequencies.

Due to the need to reduce the noise created during operation of a gas turbine engine, it would be advantageous to provide an attenuation solution that aids in for the reduction of broadband noise. In particular, it would be advantageous to provide an attenuation solution that aids in the reduction of both tonal noise and broadband noise created during operation of a gas turbine engine.

### SUMMARY

According to a first aspect there is provided A stator arrangement for use in a gas turbine engine, the arrangement comprising an inner outlet guide wall having a central axis, the inner outlet guide wall comprising a first aerofoil extending radially relative to the central axis; the an inner outlet guide wall further comprising a second aerofoil extending radially relative to the central axis, the second aerofoil being relatively displaceable between a first position and a second position; the first aerofoil combining with the second aerofoil to form a combined aerofoil when the second aerofoil is in the first position, and separating to form two or more aerofoils when the second aerofoil is relatively displaced, in use, from the first position towards the second position; wherein one or more of a profile, shape or configuration of the second aerofoil, when in the second position, are substantially identical to that of the first aerofoil.

Advantageously, the stator arrangement allows for the OGV to fan blade ratio to be manipulated depending on the operating condition during flight or according to operating conditions. This allows a reduction of both tonal and broadband noise using a single stator arrangement. The arrangement also negates the requirement for designers to compromise in optimising the OGV for one of tonal or broadband noise. Thus, designers are able to optimise a system with more OGVs for reduced tonal noise, and a system with fewer OGVs for reduced broadband noise. In this way, the arrangement provides the possibility for splitting the OGVs into two equal vanes, so increasing the number of vanes. The inner outlet guide wall and the sliding ring may be either or both of axially displaceable and relatively rotatable between a first position and a second position. This allows the arrangement to cut-off more tones. Additionally or alternatively, the arrangement provides the possibility for combining two OGVs into a single OGV to reduce the number of distinct vanes. This allows the arrangement to reduce the number of wake-leading edges interactions.

It will be appreciated that the arrangement may comprise one or more such sliding rings. Each sliding ring may be coaxially configured around the inner outlet guide wall. Each sliding ring may comprise a second aerofoil extending radially relative to the central axis. Each sliding ring may be relatively displaceable between a first position and a second position. Each sliding ring may be either or both of axially displaceable and relatively rotatable between a first position and a second position. Each sliding ring may be connected to a second aerofoil. Each sliding ring may be connected to a portion of a second aerofoil.

A pressure profile of the second aerofoil, when in the second position, may be substantially identical to that of the first aerofoil. Thus, the arrangement may be optimised for either or both of tone noise levels by providing a relatively higher number of aerofoils generating a substantially equivalent frequency or tone; and broadband noise levels by providing a relatively lower number of aerofoils. Thus, the arrangement provides a first configuration in a first position configured for broadband noise control, and a second configuration in a second position configured for tonal noise control. Thus, in the first position, the arrangement comprises a lower number of OGVs relative to the number of fan blades, which reduces the number of wake-leading edge interactions. In the second position, the arrangement comprises a higher number of OGVs relative to the number of fan blades, which cuts the first tone at the blade passing frequency, which in turn, is related to the rotational speed of the fan.

In some examples, when configured in the second position, the first aerofoil and the second aerofoil may comprise substantially identical aerodynamic profiles. In further examples, when configured in the second position, one or more of the profile, shape or configuration of the second aerofoil, may be substantially identical to that of the first aerofoil, or vice versa. In yet further examples, when configured in the second position, the pressure profile of the second aerofoil may be substantially identical to that of the first aerofoil. The pressure profile may be visualised using computational fluid dynamics (CFD) or any such further model or tool for assessing aerodynamic performance. When configured in the second position, a substantially identical pressure profile may be achieved by the first aerofoil and the second aerofoil comprising one or more of a substantially identical angle of attack, thickness, chord line length, chord line profile, camber line length, or camber line profile. In further examples, when configured in the second position, a substantially identical pressure profile may be achieved by the first aerofoil and the second aerofoil comprising a substantially identical cross-sectional shape or profile. Thus, in yet further examples, when configured in the second position, the cross-sectional profile of the second aerofoil may be substantially identical to that of the first aerofoil. When configured in the second position, the second aerofoil may be substantially identical in size to the first aerofoil. In further examples, when configured in the second position, the second aerofoil may be a different size to the first aerofoil.

The arrangement may comprise an outer outlet guide wall configured around and radially displaced from the inner outlet guide wall. The inner guide wall may be annular. The inner guide wall may be annularly arranged around the axis. The outer guide wall may be annular. The outer guide wall may be annularly arranged around the axis. The inner guide wall and the outer guide wall may be coaxial.

Either or both of the first and second aerofoil may extend between the inner outlet guide wall and the outer outlet guide wall. The first aerofoil may comprise a pressure surface. The first aerofoil may comprise a suction surface. The first aerofoil may comprise one or more pressure neutral surfaces. The second aerofoil may comprise a pressure surface. The second aerofoil may comprise a suction surface. The second aerofoil may comprise one or more pressure neutral surfaces. The first aerofoil may be attached to either or both of the inner outlet guide wall and the outer outlet guide wall. The second aerofoil may be attached to either or both of an inner sliding ring wall and an outer sliding ring wall.

Either or both of the inner outlet guide wall and outer outlet guide wall may comprise two or more segments. Each segment may comprise 1 or more first aerofoils. Each segment may comprise 2 or more first aerofoils. Each segment may comprise 4 or more first aerofoils. Either or both of the inner sliding ring wall and outer sliding ring wall may be comprised of two or more segments. Each segment may comprise 1 or more second aerofoils. Each segment may comprise 2 or more second aerofoils. Each segment may comprise 4 or more second aerofoils.

The sliding ring may be slidably engaged with the inner outlet guide wall. The sliding ring may be slidably engaged with the inner outlet guide wall via an inner sliding ring wall. The sliding ring may be located in a location feature within the inner outlet guide wall. The sliding ring may be located about the inner outlet guide wall via a retaining mechanism. The inner outlet guide wall and sliding ring may together form a smooth gas flow surface. The inner outlet guide wall and sliding ring may together form a rough or textured gas flow surface.

The sliding ring may be slidably engaged with the outer outlet guide wall. The sliding ring may be slidably engaged with the outer outlet guide wall via an outer sliding ring wall. The sliding ring may be located in a location feature within the outer outlet guide wall. The sliding ring may be located about the outer outlet guide wall via a retaining mechanism. The outer outlet guide wall and sliding ring may together form a smooth gas flow surface. The outer outlet guide wall and sliding ring may together form a rough or textured gas flow surface.

The first aerofoil and the second aerofoil may be relatively displaced between the first position and the second position when the first aerofoil and the second aerofoil are relatively rotated, in use, about the central axis. The first aerofoil and the second aerofoil may be relatively rotated from the first position towards the second position through relative displacement between the sliding ring and the inner outlet guide wall.

The first aerofoil and the second aerofoil may be relatively displaced between the first position and the second position when the first aerofoil and the second aerofoil are circumferentially displaced, in use, about the central axis. The second aerofoil may be circumferentially displaced about the central axis when displaced towards the second position.

A leading edge of the first aerofoil may be axially displaced from a leading edge of the second aerofoil when displaced, in use, between the first position and the second position. The first aerofoil and the second aerofoil may axially overlap when in the first and second positions.

At least a portion of the first aerofoil may be circumferentially aligned with at least a portion of the second aerofoil when in a first position.

The first aerofoil may be circumferentially adjacent to the second aerofoil when in a first position. The first aerofoil and the second aerofoil may abut when in the first position. A portion of the suction surface of the first aerofoil may abut against a portion of the pressure surface of the second aerofoil when in the first position. A portion of the pressure surface of the first aerofoil may abut against a portion of the suction surface of the second aerofoil when in the first position.

The first aerofoil may be axially adjacent to the second aerofoil when in a first position. A portion of the trailing edge of the first aerofoil may abut against a portion of the leading edge of the second aerofoil when in the first position. A portion of leading edge of the first aerofoil may abut against a portion of the trailing edge of the second aerofoil when in the first position. A portion of the trailing edge of the first aerofoil may be axially aligned with a portion of the leading edge of the second aerofoil when in the first position. A portion of leading edge of the first aerofoil may be axially aligned with a portion of the trailing edge of the second aerofoil when in the first position. The first and second aerofoils may form a substantially smooth pressure and suction face when in the first position. The first and second aerofoils may form a substantially smooth aerofoil when in the first position.

Either or both of the first aerofoil and second aerofoil may be rotatable about an axis comprising a radial component relative to the central axis. The axis comprising a radial component may be substantially perpendicular to the central axis. The axis comprising a radial component relative to the central axis may comprise an axial component. The axis comprising a radial component may be canted from an axis perpendicular to the central axis.

The stator arrangement may be an outlet guide vane for incorporation within a gas turbine engine. The stator arrangement may be an inlet guide vane for incorporation within a gas turbine engine. The stator arrangement may be a variable vane for incorporation within a gas turbine engine.

The stator arrangement may be incorporated within an outlet guide vane stage for incorporation within a gas turbine engine. The stator arrangement may be controlled by a controller. The controller may be linked to an engine management system. Either or both of the engine management system or the controller may vary the displacement of the inner outlet guide wall relative to the sliding ring according to a process condition. Either or both of the engine management system or the controller may vary the displacement of the inner outlet guide wall relative to the sliding ring according to an engine operating condition or an environmental condition. Either or both of the engine management system or the controller may comprise a sensor for sensing an engine operating condition or an environmental condition.

According to a second aspect, there is provided a stator arrangement for use in a gas turbine engine, the arrangement comprising an inner outlet guide wall having a central axis, the inner outlet guide wall comprising a first aerofoil extending radially relative to the central axis; a sliding ring coaxially configured around the inner outlet guide wall, the sliding ring comprising a second aerofoil extending radially relative to the central axis, the inner outlet guide wall and the sliding ring being relatively displaceable between a first position and a second position; the first aerofoil combining with the second aerofoil to form a combined aerofoil when the inner outlet guide wall and the sliding ring are in the first position, and separating to form two or more aerofoils when the inner outlet guide wall and the sliding ring are relatively displaced, in use, from the first position towards the second position; wherein one or more of a profile, shape or configuration of the second aerofoil, when in the second position, are substantially identical to that of the first aerofoil.

A pressure profile of the second aerofoil, when in the second position, may be substantially identical to that of the first aerofoil.

A cross-sectional profile of the second aerofoil, when in the second position, may be substantially identical to that of the first aerofoil.

According to a third aspect, there is provided a gas turbine comprising the stator arrangement previously described. Alternatively, the stator arrangement previously described may be incorporated within a rotating machine.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DETAILED DESCRIPTION OF THE DRAWINGS

Embodiments will now be described by way of example only, with reference to the Figures, in which:

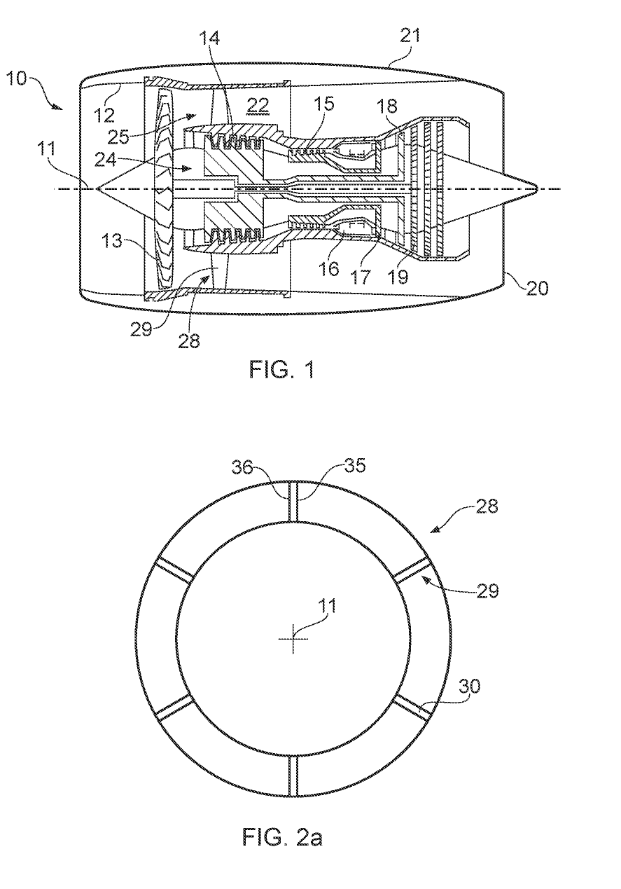

FIG. 1 is a sectional side view of a gas turbine engine;

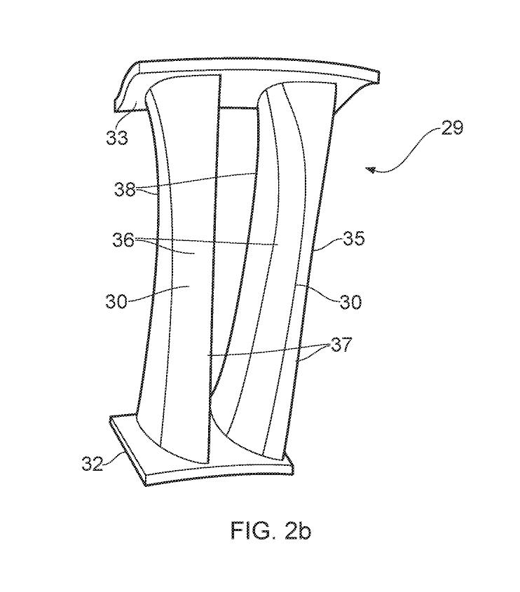

FIG. 2a is a frontal cross-section of an OGV stage;

FIG. 2b is a frontal view of an OGV forming the OGV stage;

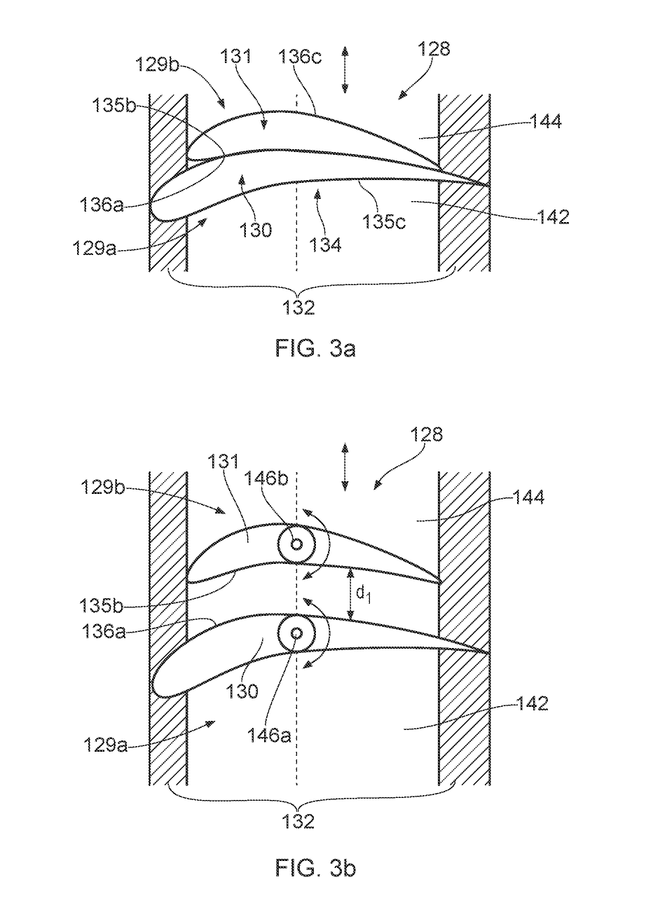

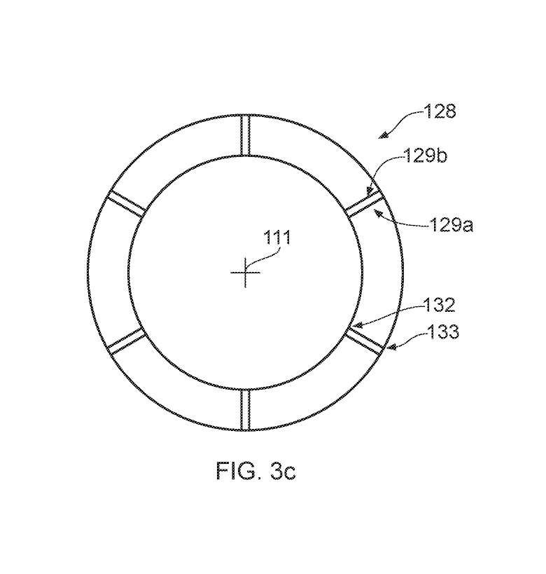

FIG. 3a is a plan view of a first and second aerofoil of an OGV stage in a first position;

FIG. 3b is a plan view of a first and second aerofoil of an OGV stage in a second position;

FIG. 3c is a frontal view of an OGV stage;

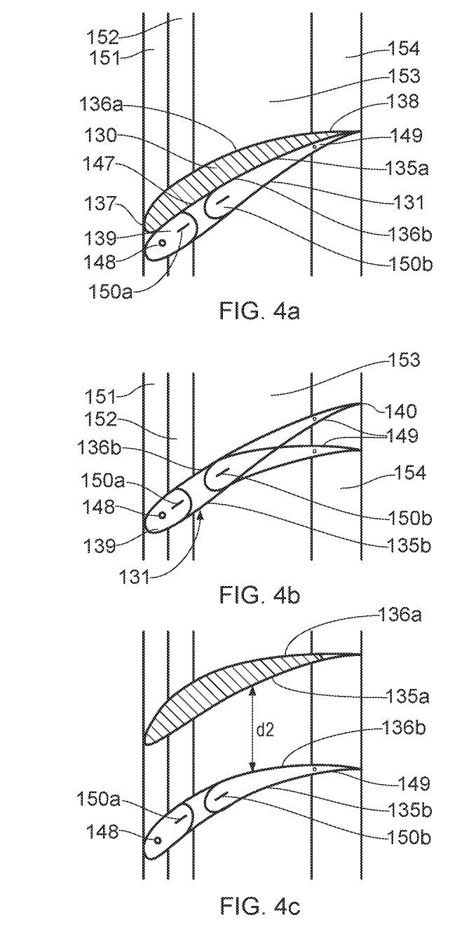

FIG. 4a is a plan view of a first and second aerofoil of an OGV stage in a first position;

FIG. 4b is a plan view of a first aerofoil of the OGV;

FIG. 4c is a plan view of a first and second aerofoil of an OGV stage in a second position;

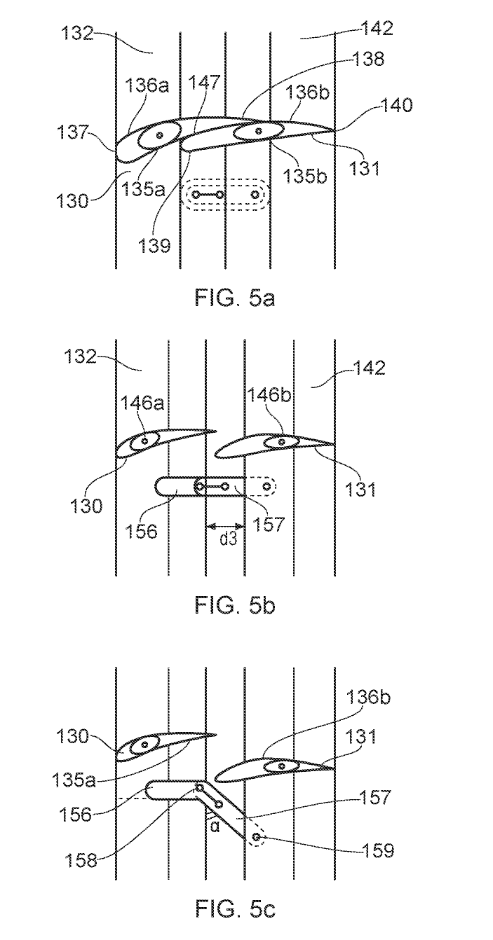

FIG. 5a is a plan view of a first and second aerofoil of an OGV stage in a first position;

FIG. 5b is a plan view of a first and second aerofoil of an OGV stage in an axially displaced position; and,

FIG. 5c is a plan view of a first and second aerofoil of an OGV stage in a second position.

### DETAILED DESCRIPTION

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow 24 into the intermediate pressure compressor 14 and a second air flow 25 which passes through a bypass duct 22 to provide propulsive thrust. Within the bypass duct 22, the second air flow 25 is directed towards the rear of the gas turbine engine by one or more outlet guide vane (OGV) stages 28, each stage comprising a plurality of outlet stator vanes 29. Concurrently, the first air flow 24 is fed into the intermediate pressure compressor 14 which compresses the air flow and delivers it to the high pressure compressor 15, where further compression takes place. The compressed air exhausted from the high-pressure compressor 15 is directed into the combustion equipment 16, where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

It is common for an amount of noise to be created by interaction of the first air flow 24 and second air flow 25 travelling through the engine with constituent components of the gas turbine engine assembly. In particular, it is common for an amount of noise to be created by the second air flow 25 interacting with one or more guide vane (GV) stages 28. To address noise levels, current gas turbine engines are designed to reduce tonal noise by tuning the number of vanes 29 of a particular GV stage 28 to rotor blades 13, according to a design rule derived from the Tyler-Sofrin rule:

(no. of OGVs)>(2*no. of rotor blades)+4

However, using this rule increases the broadband noise created by the gas turbine engine 10 due to an increased number of GVs 29 and thus turbulent wakes impinging on the leading edges of the GVs 29. This is particularly pertinent for future engine programmes where reduced rotational fan speeds and alternate fan blade designs may create a different loading and/or more powerful and energetic wake energy content. Such modifications may lead to a “rise” in the broadband noise carpet and attenuated tones in the frequency spectrum. Thus, it is recognised that in addition to tonal noise levels, the levels of broadband noise must be addressed and reduced accordingly.

In contradiction of the Tyler-Sofrin rule outlined to reduce tonal noise, the current method to reduce broadband noise is to reduce the number of wake-blade interactions by reducing the number of GVs 29. Due to contradicting methods for the reduction of respective tonal and broadband noise types, future engine programmes require a new design rule or solution for the reduction of both tonal and broadband noise.

FIG. 2a shows a frontal cross-section of an OGV stage 28 known within the art, viewed from a forward position of the second air flow 25 towards an aft position of the second air flow 25. The OGV stage 28 comprises an annular array of OGVs 29 (shown in FIG. 2b), each OGV 29 comprising an aerofoil 30 which extends between an inner outlet guide wall 32 and an outer outlet guide wall 33. The inner outlet guide wall 32 and outer outlet guide wall 33 each extend circumferentially around a central axis 11. Each aerofoil 30 comprises two or more outwardly facing surfaces. In some examples, the outwardly facing surfaces comprise a pressure surface 35 and a suction surface 36. In an alternative example the two or more outwardly facing surfaces comprise two or more pressure-neutral surfaces. Aft of the OGV stage 28, the inner and outer outlet guide walls 33 form at least a portion of the bypass duct. In further examples, aft of the OGV stage 28, the inner and outer outlet guide walls 33 form the bypass duct. The OGV stage 28 is secured to, and held in position by one or more fairings as part of a support structure (not shown).

FIG. 2b shows a frontal view of the OGV 29, which forms the OGV stage 28 previously shown in FIG. 2a. The OGV 29 shown comprises a pair of aerofoils 30, each comprising a pressure surface 35 and a suction surface 36. In further examples, the OGV 29 may comprise three or more aerofoils 30. In further examples, the OGV 29 may comprise a single aerofoil 30. Each aerofoil 30 is disposed between the inner outlet guide wall 32 and the outer outlet guide wall 33, each aerofoil 30 being separated from one or more adjacent aerofoils 30 by a circumferential spacing. Each aerofoil 30 comprises a radial span length, the radial span length being measured between the inner outlet guide wall 32 and the outer outlet guide wall 33, and an axial length defining the length of the blade parallel to the central axis 11. Each aerofoil 30 comprises a leading edge 37 and a trailing edge 38 separated by a chord length. The spacing defined between the inner outlet guide wall 32, outer outlet guide wall 33 and the respective aerofoils 30 together define one or more flow passages for the first air flow 24 to flow from from a forward position towards an aft position.

In the example shown, the aerofoils 30 are formed as separate components which are subsequently fastened or joined together around the inner 32 and outer 33 guide walls. In this way, the OGVs 29 are annularly arranged and secured to the one or more fairings as part of a support structure (not shown) to form the OGV stage 28. In some examples, the OGV 29 can be produced as a single ring. For example, the ring could be manufactured by casting or forging to net-shape, or to near net-shape, before finishing by a suitable traditional or non-traditional machining process. The OGV 29 structure could be produced in its entirety as a single component.

FIGS. 3a and 3b show a plan view of a first OGV 129a and a second OGV 129b as part of an OGV stage 128, the OGV stage 128 being optimised for both tonal noise and broadband noise reduction. This is achieved by varying the number of distinct aerofoils 130,131 within the OGV stage 128. The number of distinct aerofoils 130 within the OGV stage 128 varies, during use, between a first number of aerofoils 130 and a second number of aerofoils 131. In some examples, the first number and second number of aerofoils 130,131 are provided in accordance with a tonal and broadband noise optimisation rule. In some examples, the first number and second number of aerofoils 130,131 are provided in accordance with the Tyler-Sofrin rule.

FIG. 3c shows a frontal cross-section of the OGV stage 128, viewed from a forward position of the second air flow 25 towards an aft position of the second air flow 25. The OGV stage 128 comprises an annular array of first OGV 129a and a second OGV 129b as part of an OGV stage 128. The OGV stage 128 is optimised for both tonal noise and broadband noise reduction. Each of the first OGVs 129a and second OGVs 129b extend between an inner outlet guide wall 132 and an outer outlet guide wall 133. The inner outlet guide wall 132 and outer outlet guide wall 133 each extend circumferentially around a central axis 111.

In FIG. 3a, the first OGV 129a is shown to comprise an inner outlet guide wall 132. The first OGV 129a further comprises the outer outlet guide wall 133 configured around and radially displaced from the inner outlet guide wall 132. The inner outlet guide wall 132 and outer outlet guide wall 133 each extend circumferentially around the central axis 111. In some examples, the first and second OGVs 129a,129b are formed into an annular arrangement of OGVs 129a,129b to form the OGV stage 128. In some examples, the inner outlet guide walls 132 can be a single component to which respective OGVs 129a,129b may be coupled. The inner outlet guide wall 132 comprises a first aerofoil 130 extending radially relative to the central axis 111. In some examples, the inner outlet guide wall 132 comprises one or more first aerofoils 130 extending radially relative to the central axis 111. In some examples, the inner outlet guide wall 132 can comprise an annular arrangement of two or more first aerofoils 130. The first aerofoil 130 extends between the inner outlet guide wall 132 and the outer outlet guide wall 133. In some examples, the inner outlet guide wall 132 and outer outlet guide wall 133 extend circumferentially around the central axis 111. Thus, the or each first aerofoil 130 is circumferentially distributed around the central axis 111.

The second OGV 129b is shown to comprise a sliding ring 142 coaxially configured around the inner outlet guide wall 132. The sliding ring 142 comprises an inner sliding ring guide wall 144. The sliding ring 142 comprises a second aerofoil 131 extending radially relative to the central axis 111. In some examples, the sliding ring 142 comprises one or more second aerofoils 131 extending radially relative to the central axis 111. In some examples, the inner outlet guide wall 132 can comprise an annular arrangement of two or more second aerofoils 131. In further examples, the sliding ring 142 is slidably engaged with a radially outer surface of the inner outlet guide wall 132. The second aerofoil 131 extends between the inner sliding ring guide wall 144 and a receiving portion in the outer outlet guide wall 133. In further examples, the second aerofoil 131 extends between the inner sliding ring guide wall 144 and an outer sliding ring guide wall (not shown). In further examples, the sliding ring 142 is slidably engaged with a radially inner surface of the outer outlet guide wall 133. In this way, the inner outlet guide wall 132 and the sliding ring 142 are relatively rotatable between a first position and a second position.

The surfaces of the inner outlet guide wall 132, outer outlet guide wall 133, first and second aerofoils 131,132 and respective sliding rings together define one or more flow passages for the first air flow 24 to flow from from a forward position towards an aft position. In some examples, the sliding ring 142 may be located in a recess within the inner outlet guide wall 132. In this way, the sliding ring 142 and inner outlet guide wall 132 may together form a combined smooth gas-washed surface over which the first air flow 24 may pass. Thus, an outer sliding ring may be located in a recess within the outer outlet guide wall 133. In this way, the outer sliding ring and outer outlet guide wall 133 may together form a combined smooth gas-washed surface over which the first air flow 24 may pass. In further examples, the sliding ring 142 may abut against the inner outlet guide wall 132. Thus, the sliding ring 142 may radially project from either or both of the inner outlet guide wall 132 and outer outlet guide wall 133 and may together form a roughened or textured gas-washed surface over which the second air flow may pass. In some examples, the arrangements described in relation to the inner annulus, including the arrangement of the inner outlet guide wall 132 and sliding ring 142, may be replicated in the arrangements for the outer annulus and sliding ring 142. Alternatively, any one or more of the described arrangements for the inner outlet guide wall 132 and sliding ring 142 may be used for the outer annulus in conjunction with the described arrangements for the inner annulus shown in FIGS. 3a to 5c.

For one or more of the inner outlet guide wall 132 and the outer outlet guide wall 133, rotation of the sliding ring 142 may be provided by an internal or external structure, such as a mechanical linkage arrangement or a mechanical drive such as a motor, arranged radially inwards of the inner outlet guide wall 132 or radially outwards of the outer outlet guide wall 133. Such an arrangement may cause a rotation of the sliding ring 142 relative to both the inner outlet guide wall 132 and the outer outlet guide wall 133. Such arrangements may be similar to those currently known for use with variable inlet guide vanes (VIGVs). Such arrangements may also include one or more of a bearing race or lubrication to reduce the frictional force between the inner outlet guide wall 132 and the outer outlet guide wall 133. Such arrangements may also include a slot or shaped section in either or both of the inner outlet guide wall 132 and the outer outlet guide wall 133 for location of the sliding ring 142 therein.

To provide relative displacement between the first and second positions, the first aerofoil 130 is provided on the inner outlet guide wall 132 at a first axial location. The second aerofoil 131 is provided on the sliding ring 142 at a second axial location. The first 130 and second aerofoils 131 have an approximately equal radial displacement relative to the central axis 111. The inner outlet guide wall 132 and the sliding ring 142 are configured to be relatively rotatable about the central axis 111, allowing circumferential displacement between the inner outlet guide wall 132 and the sliding ring 142. In this way, relative displacement between the inner outlet guide wall 132 and the sliding ring 142 provides a corresponding displacement between the first OGV 129a and the second OGV 129b. Thus, in some examples, relative displacement between the first OGV 129a and the second OGV 129b provides a corresponding displacement between the first 130 and second aerofoils 131.

When the first OGV 129a and the second OGV 129b are configured in a first position, shown in FIG. 3a, the first aerofoil 130 and the second aerofoil 131 are configured to abut against one another. Thus, at least a portion of the first aerofoil 130 and the second aerofoil 131 comprise a mating surface, one or more of the profile, shape or configuration of one such aerofoil being at least partially replicated in the corresponding aerofoil 130,131. As shown, at least a portion of a suction surface 136a of the first aerofoil 130 is shown to be in abutment with at least a portion of a pressure surface 135b of the second aerofoil 131. Thus, the first 130 and second aerofoils 131, when in the first position, combine to form a single aerofoil or component 134. In some examples, the component 134, when the first 130 and second aerofoils 131 are in the first position, comprises a substantially smooth aerofoil-like profile, comprising a suction surface 136c and a pressure surface 135c. Thus, at least one surface of each of the first 130 and second aerofoils 131 provide a gas-washed surface 136c,135c of the single aerofoil or component 134, when the first 130 and second aerofoils 131 are in the first position. In some examples, at least one surface of each of the first 130 and second aerofoils 131 does not provide a gas-washed surface 136c,135c of the single aerofoil or component 134, when the first 130 and second aerofoils 131 are in the first position. Thus, in some examples, at least one surface of each of the first 130 and second aerofoils 131 is shielded from the first air flow 24, when the first 130 and second aerofoils 131 are in the first position. In such examples, the at least one surface of each of the first 130 aerofoil is shielded due to being in abutment with the second aerofoil 131 when the first 130 and second aerofoils 131 are in the first position.

By the first 130 and second 131 aerofoils combining to form a single component 134, the number of separated aerofoils 130,131 within the OGV stage 128 when in the first position is reduced relative to the number of separated aerofoils 130,131 within the OGV stage 128 when in the second position. This reduces the wake-leading edge interactions within the second airflow 25 of the gas turbine engine 100. Thus, the combined broadband noise is reduced.

In FIG. 3b, when the first OGV 129a and the second OGV 129b are configured in a second position, the first OGV 129a and the second OGV 129b have been relatively rotated from the first position towards the second position. Thus, the inner outlet guide wall 132 and the inner sliding ring guide wall 144 have been relatively rotated from the first position towards the second position. Such relative rotation provides a circumferential displacement, labelled d1 in FIG. 3b, between the first aerofoil 130 and the second aerofoil 131. Thus, at least a portion of the suction surface 136a of the first aerofoil 130 is circumferentially displaced from at least a portion of the pressure surface 135b of the second aerofoil 131. Thus, the first 130 and second aerofoils 131 as a combined component 134, when displaced towards the second position, separate to form two separate aerofoils 130,131 or components. In some examples, when displaced towards the second position, the number of distinct aerofoils 130,131 within the second air flow 25 is increased to the number of separable aerofoils 130,131 comprised as part of the inner outlet guide wall 132 and the sliding ring 142. Thus, the number of separated aerofoils 130,131 within the OGV stage 128 when in the second position is increased relative to the number of separated aerofoils 130,131, or combined components 134, within the OGV stage 128 when in the first position. Increasing the number of aerofoils 130,131 within the second air flow 25 cuts tones at the blade passing frequencies, the frequency of which relates to the rotational speed of the fan 13. In this way, the tonal noise of the aerofoil arrangement when displaced towards the second position is reduced over the tonal noise of the aerofoil arrangement when in the first position according to the previously described Tyler-Sofrin rule.

The entirety of either or both of the first 130 and second aerofoils 131 may be circumferentially displaced from the first position towards the second position. Alternatively, a portion of either or both of the first 130 and second 131 aerofoils may be circumferentially displaced from the first position towards the second position. Thus, one or more portions of either or both of the first 130 and second 131 aerofoils may remain static.

As shown in FIG. 3b, either or both of the first 130 and second 131 aerofoils may be configured to pivot about either or both of a respective first and second fulcrum 146a,146b via a pivot arrangement. As shown in FIG. 3b, the first and second fulcrum 146a,146b are aligned with a radial axis which is perpendicular to the central axis 111 of the gas turbine engine 100. The fulcrum 146a,146b is located at an approximate mid-chord point of either or both of the first 130 and second 131 aerofoils. Thus, either or both of the first 130 and second 131 aerofoils may pivot about the fulcrum 146a,146b. In some examples, the fulcrum 146a,146b may be provided by a body extending from the sliding ring 142 into the second 131 aerofoil about which the second aerofoil 131 may pivot. In alternative examples, the fulcrum 146a,146b might be an approximate location about which the first 130 and second 131 aerofoils pivot due to differential circumferential displacements between the inner outlet guide wall 132 and either the inner sliding ring guide wall 144 or a further sliding ring (not shown). In this way, either or both of the pitch or the camber of the first 130 and second aerofoils 131 may be varied according to requirements. The pitch of the first 130 and second 131 aerofoils may be varied to alter the aerodynamic profile of the respective aerofoils 130,131. In further examples, the pitch of the first 130 and second 131 aerofoils may be varied to allow the first 130 and second 131 aerofoil to orientate the first 130 and second 131 aerofoils so that they may be combined in the first position. In yet further examples, the first 130 and second 131 aerofoils may be provided with variable camber. Adapting the camber of the aerofoils 130,131 may aid in providing each aerofoil 130,131 around the annulus with the equivalent, or identical loading. Thus, the provision of one or more of equal pitch, loading or camber aids in the prevention of multiple types of tones occurring within the annular arrangement.

Referring now to FIGS. 4a to 4c, further examples depicting the configuration of the first 130 and second aerofoils 131, when in the first and second position, are depicted. In particular, FIGS. 4a to 4c show an arrangement for providing a variable number of aerofoils with the OGV stage 128. This is achieved by circumferentially separating the first 130 and second aerofoils 131, which together form a single component 134, to form a plurality of circumferentially separated aerofoils 130,131. Additionally, FIGS. 4a to 4c show an arrangement for adapting the camber of the circumferentially separated aerofoils in order to provide a substantially equal aerofoil and loading profile for each of the first and second aerofoils 130,131 configured within the OGV stage 128.

As described in relation to FIGS. 3a to 3b, the first OGV 129a and second OGV 129b are configured to be relatively rotatable about the central axis 111 to provide a circumferential displacement, labelled d2 in FIG. 4c, between the first 130 and second aerofoils 131 as they are displaced from a first position towards a second position. It will be appreciated that the second OGV 129b may comprise one or more second aerofoils 131. In this way, the number of separated aerofoils 130,131 within the OGV stage 128 when in the second position is increased relative to the number of combined aerofoils 134 within the OGV stage 128 when in the first position. Thus, the number of separated aerofoils 130,131 within the OGV stage 128 is increased, when displaced towards the second positon, by the number of second aerofoils 131 comprised in the second OGV 129b. The number of second aerofoils 131 comprised in the second OGV 129b may be, in some examples, any number between 1 and the number of aerofoils comprised in the first OGV 129a. Alternatively, the number of second aerofoils comprised in the second OGV 129b may be, in some examples, any number between 4 and the number of aerofoils comprised in the first OGV 129a. Further alternatively, the number of second aerofoils comprised in the second OGV 129b may be, in some examples, any number between 6 and the number of aerofoils comprised in the first OGV 129a. Thus, the number of second aerofoils comprised in the second OGV 129b may equal the number of aerofoils comprised in the first OGV 129a.

In further examples, the number of second aerofoils comprised in the second OGV 129b may exceed the number of aerofoils comprised in the first OGV 129a. Thus, in some examples, the number of separated aerofoils 130,131 within the OGV stage 128 is increased, when displaced towards the second positon, by the number of second aerofoils 131 comprised in the first OGV 129a.

As shown in FIG. 4a, the OGV stage 128 comprises a first aerofoil 130 and a second aerofoil 131 in a first position described in relation to FIG. 3a. The second aerofoil 131 is circumferentially displaceable relative to the first aerofoil 130 whilst additionally allowing the camber of the second aerofoil 131 to be adjusted according to requirements. At least a portion of the first aerofoil 130 and the second aerofoil 131 comprise a mating surface 147, one or more of the profile, shape or configuration of one such aerofoil being at least partially replicated in the corresponding aerofoil 130,131. As shown in FIG. 4a, at least a portion of the pressure surface 135a of the first aerofoil 130 is shown in abutment with at least a portion of a suction surface 136b of the second aerofoil 131. Thus, the first 130 and second aerofoils 131, when in the first position, combine to form a single aerofoil or component 134. The single aerofoil or component 134 comprises a generally smooth profile, comprising a suction surface, a pressure surface, a leading edge and a trailing edge. In the arrangements shown in both FIGS. 3a to 3b, and FIGS. 4a to 4c, it will be appreciated that if the axial lengths of the first 130 and second aerofoils 131 are disparate when in the first position, the axially longer of the first 130 and second aerofoils 131 will form a portion of the component 134 comprising two or more of the suction surface, the pressure surface, the leading edge and the trailing edge. Conversely, the axially shorter of the first 130 and second aerofoils 131 will form a portion of the component 134 comprising one or more of the suction surface, the pressure surface, the leading edge and the trailing edge. If the axial lengths of the first 130 and second aerofoils 131 are equal when in the first position, the first 130 and second aerofoils 131 will form a portion of the component 134 comprising three or more portions of the suction surface, the pressure surface, the leading edge and the trailing edge.

In further examples, both the first aerofoil 130 and the second aerofoil 131 may comprise a fulcrum, further to the arrangement shown in FIGS. 3a and 3b, to allow adaptive camber as required. As shown in FIG. 4a, the first aerofoil 130 comprises a leading edge 137 and a trailing edge 138, a suction surface 136a and a pressure surface 135a in accordance with aerofoils known within the art. As shown in FIG. 4b, the second aerofoil 131 comprises a leading edge 139 and a trailing edge 140 body, the leading edge 139 body being mounted to a first ring 151 and the trailing edge 140 body being mounted to a fourth ring 154. The leading and trailing edge bodies 139,140 of the second aerofoil 131 are mounted to the respective rings via fore and aft fulcrum arrangements 148,149. A portion of the leading edge body 139 of the second aerofoil 131 is configured to be received between the pressure 135b and suction 136b surfaces of the second aerofoil 131. Thus, a recess is provided between the pressure 135b and suction 136b surfaces of the second aerofoil 131 into which at least a portion of the leading edge 139 body may retract via a slot 150a. During this action, a sliding of the first ring 151 relative to the second ring 152 will cause the portion of the leading edge body 139 to be circumferentially displaced about the fore fulcrum arrangement 148 and the slot 150a. Thus, the leading edge 139 body is caused to be radially and circumferentially displaced relative to the pressure 135b and suction 136b surfaces via the slot 150a.

A portion of the trailing edge 140 body of the second aerofoil 131 is configured to be received between the pressure 135b and suction 136b surfaces of the second aerofoil 131. Thus, a recess is provided between the pressure 135b and suction 136b surfaces of the second aerofoil 131 into which at least a portion of the trailing edge 140 body may retract via a slot 150b. During this action, a sliding of the fourth ring 154 relative to the third ring 153 will cause the portion of the trailing edge body 140 to be circumferentially displaced about the aft fulcrum arrangement 149 and the slot 150b. Thus, the trailing edge body 140 is caused to be radially and circumferentially displaced relative to the pressure 135b and suction 136b surfaces via the slot 150b.

Further to the leading and trailing edge bodies 139,140, a portion of the pressure 135b and suction 136b surfaces of the second aerofoil 131 are fixedly attached to the second ring 152. In this way, the leading edge 139 and trailing edge 140 bodies, other than the fore and an aft fulcrum arrangements 148,149, are radially displaced from the first 151, third 153 and fourth 154 rings to allow relative movement between the respective rings 151,152,153,154 and the second aerofoil 131. In this way, circumferential displacement of the fourth ring 154 relative to the second ring 152 and results in a displacement of at least a portion of the second aerofoil 131, relative to the portion of the pressure and suction 135b,136b surface fixedly attached to the second ring 152. Such displacement is about the slot 150b.

Referring now to FIG. 4c, a portion of the pressure 135a and suction 136a surfaces of the first aerofoil 130 are fixedly attached to the third ring 153. In this way, the leading edge 137 and trailing edge 138 bodies are radially displaced from the first 151, second 152 and fourth 154 rings to allow relative movement between the respective rings and the first aerofoil 130. In some examples, the third ring 153 remains static. Thus, the first 151, second 152 and fourth 154 rings may be independently circumferentially displaced relative to the third ring 153. In further examples, the third ring 153 may itself be circumferentially displaced. Thus, all rings 151,152,153,154 may be relatively rotated according to requirements. Through the ability of the rings 151,152,153,154 to each undergo relative rotation, the first 151, second 152, third 153 and fourth 154 rings may be individually displaced at different rates allow both a circumferential displacement of the first 130 and second aerofoils 131, whilst also allowing the camber and shape of the second aerofoil 131 to be modified according to requirements.

The first aerofoil 130 is fixedly attached to a single fixed ring 153 only over the axial width of the third ring 153, limiting adjustment of the camber of the aerofoil 130. The remainder parts 137,138 of the first aerofoil 130 are radially displaced from the first 151, second 152 and fourth 154 rings to allow relative movement between the rings 151, 152,154 and the first aerofoil 130.

As described in relation to FIGS. 3a to 3b, for one or more of the inner outlet guide wall 132 and the outer outlet guide wall 133, rotation of one or more of the sliding rings 151,152,153,154, as part of a sliding ring arrangement, may be provided by one or more internal or external structures, such as one or more mechanical linkage arrangements or one or more mechanical drives such as a motor, arranged radially inwards of the inner outlet guide wall 132 or radially outwards of the outer outlet guide wall 133. Such an arrangement may cause a rotation of one or more of the sliding rings 151,152,153,154 relative to both the inner outlet guide wall 132 and the outer outlet guide wall 133. Such arrangements may also include one or more of a bearing race or lubrication to reduce the frictional force between the inner outlet guide wall 132 and the outer outlet guide wall 133. Such arrangements may also include a slot or shaped section in either or both of the inner outlet guide wall 132 and the outer outlet guide wall 133 for location of one or more of the sliding rings 151,152,153,154 therein.

According to some examples, when configured in the second position, one or more of the profile, shape or configuration of the second aerofoil 131, are substantially identical to that of the first aerofoil 130, or vice versa. According to further examples, as shown in FIGS. 3a to 3b and 4a to 4c, when configured in the second position, the first aerofoil 130 and the second aerofoil 131 comprise substantially identical aerodynamic profiles. According to yet further examples, when configured in the second position, the pressure profile of the second aerofoil 131 is substantially identical to that of the first aerofoil 130. Thus, the arrangement provides a uniform pressure distribution across the whole annulus, at each radial position.

Any one or more of the aerodynamic profile, profile, shape, configuration, and pressure profile may be visualised using computational fluid dynamics (CFD) or any such further model or tool for assessing aerodynamic performance. In particular, the pressure profile distribution over either or both of the first aerofoil 130 and the second aerofoil 131 may be quantified numerically by using, for example, by using simple CFD codes to calculate the pressure profile on each section of a 3D blade to take into account the twisted shape of the blade. Furthermore, the pressure profile distribution over either or both of the first aerofoil 130 and the second aerofoil 131 may be quantified empirically by using, for example, velocity field measurement techniques such as particle image velocimetry (PIV), or laser Doppler velocimetry (LDV).

When configured in the second position, a substantially identical pressure profile may be achieved by the first aerofoil 130 and the second aerofoil 131 comprising one or more of a substantially identical angle of attack, thickness, chord line length, chord line profile, camber line length or camber line profile. In further examples, when configured in the second position, a substantially identical pressure profile may be achieved by the first aerofoil 130 and the second aerofoil 131 comprising a substantially identical cross-sectional shape or profile. In some examples, as shown in FIGS. 4a to 4c, when configured in the second position, the second aerofoil 131 may be substantially identical in size to the first aerofoil 130. In further examples, as shown in FIGS. 3a to 3b, when configured in the second position, the second aerofoil 131 may be a different size to the first aerofoil 130.

By virtue of the second aerofoil 131, when in the second position, comprising a substantially identical profile, shape or configuration to that of the first aerofoil 130, the arrangement provides the ability to apply the Tyler-Sofrin rule without any further modification. Thus, second airflow 25 flowing towards the OGV stage 128 from the fan 13 observes the same pressure profile at the first 130 and second 131 aerofoil, which reduces the potential for the formation of multiple tones. Thus, the potential for increased tonal noise is reduced. In further examples, when configured in the second position, the gap between the first aerofoil 130 and the second aerofoil 131 may be controlled in accordance with predetermined conditions, parameters or requirements. With regards to broadband noise, a single tone resulting from the second aerofoil 131, when in the second position, comprising a substantially identical profile, shape or configuration to that of the first aerofoil 130, provides a singular acoustic response resulting from the wakes impinging on the first 130 and second 131 aerofoils. Thus, second airflow 25 flowing towards the first 130 and second 131 aerofoils from the fan 13 observes the same pressure profile at the first 130 and second 131 aerofoil, which reduces the potential for the formation of multiple “broadband” signatures, and the potential for increased broadband noise as a result.

By virtue of the first aerofoil 130 and second aerofoil 131 comprising a substantially identical profile, shape or configuration when in the second position, such that the pressure profile of the second aerofoil 131 is substantially identical to that of the first aerofoil 130, the first aerofoil 130 and second aerofoil 131 are capable of exerting an equivalent straightening effect on the second airflow 25. To modify the straightening effect, one or more of the profile, shape or configuration of either or both of the first aerofoil 130 and second aerofoil 131 may be altered as required, as shown in FIGS. 4a to 4c. Such alteration can ensure an equivalent air angle of both of the first aerofoil 130 and second aerofoil 131 within the second airflow 25. In some examples, the air angle may be close to, or equal to zero, to minimise thrust loss.

FIGS. 5a to 5c show a further axially displaced configuration of the first 130 and second 131 aerofoils 131 when in the first and second position. In particular, FIGS. 5a to 5c show an arrangement for providing a variable number of aerofoils 130,131 within the OGV stage 128. This is achieved by circumferentially separating the first 130 and second aerofoils 131, which together form a single component 134, to form a plurality of circumferentially separated aerofoils 130,131. Additionally or alternatively, this can be achieved by axially separating the first 130 and second aerofoils 131 to form a plurality of both circumferentially and axially separated aerofoils 130,131. FIGS. 5a to 5c show an arrangement for adapting the camber of the circumferentially separated aerofoils 130,131 in order to provide a substantially equal aerofoil and loading profile for each of the first 130 and second 131 aerofoils configured within the OGV stage 128.

As previously described in relation to FIGS. 3a to 3b and 4a to 4c, the first OGV 129a and second OGV 129b are configured to be relatively rotatable about the central axis 111 to provide a circumferential displacement between the first 130 and second aerofoils 131 as they are displaced from a first position towards a second position. The arrangement of FIGS. 5a to 5c differs from previously described examples in the arrangement and location of the sliding ring 142 relative to the inner outlet guide wall 132. In each of FIGS. 5a to 5c, the sliding ring 142 is coaxially configured around, but axially displaced from the inner outlet guide wall 132. In some examples, the sliding ring 142 is slidably engaged with a radially inner surface of the outer outlet guide wall 133. In this way, the inner outlet guide wall 132 and the sliding ring 142 are relatively displaceable between a first position and a second position. Thus, the inner outlet guide wall 132 and the sliding ring 142 are relatively displaceable between a first axial position and a second axial position.

As shown in FIG. 5a, the OGV stage 128 comprises a first aerofoil 130 and a second aerofoil 131 in a first position. The second aerofoil 131 is circumferentially displaceable relative to the first aerofoil 130 whilst additionally allowing the camber of the aerofoil to be adjusted according to requirements.

The first aerofoil 130 comprises a leading edge 137 and a trailing edge 138, a suction 136a surface and a pressure surface 135a. The first aerofoil 130 is shown to be attached to the inner outlet guide wall 132. At least a portion of the first aerofoil 130 is shown to extend axially from the inner outlet guide wall 132 to a location aft of the inner outlet guide wall 132. When in the first position, a portion of the trailing edge 138 of the first aerofoil 130 extends axially over a portion of the sliding ring 142. Thus, the portion of the first aerofoil 130 which extends axially from the inner outlet guide wall 132 is radially displaced from the sliding ring 142 to allow relative movement of the first aerofoil 130 and the sliding ring 142.

The second aerofoil 131 comprises a leading edge 139 and a trailing edge 140, a suction surface 136b and a pressure surface 135b. The second aerofoil 131 is shown to be attached to the sliding ring 142. At least a portion of the second aerofoil 131 is shown to extend axially from the sliding ring 142 to a location forward of the sliding ring 142. When in the first position, a portion of the leading edge 139 of the second aerofoil 131 extends axially over a portion of the inner outlet guide wall 132. Thus, the portion of the second aerofoil 131 which extends axially from the sliding ring 142 is radially displaced from the inner outlet guide wall 132 to allow relative movement of the second aerofoil 131 and the inner outlet guide wall 132.

In accordance with the described arrangement, the portion of the inner outlet guide wall 132 comprising the first aerofoil 130 is shown to be forward of the sliding ring 142. In some examples, the portion of the inner outlet guide wall 132 comprising the first aerofoil 130 may be to be forward of the sliding ring 142, with corresponding changes in the design and mating geometry of the first 130 and second aerofoils 131 as required. In either case, the first 130 and second aerofoils 131 are axially displaced relative to one another in both a first and a second position. Thus, when the first OGV 129a and the second OGV 129b are configured in a first position, shown in FIG. 5a, the first aerofoil 130 and the second aerofoil 131 are configured to abut against one another. At least a portion of the first aerofoil 130 and the second aerofoil 131 forms a mating surface 147, one or more of the profile, shape or configuration of one such aerofoil being at least partially replicated in the corresponding aerofoil. As shown in FIG. 5a, at least a portion of the pressure surface 135a of the first aerofoil 130 is shown to be in abutment with at least a portion of a suction surface 136b of the second aerofoil 131. Thus, the first 130 and second aerofoils 131, when in the first position, combine to form a single aerofoil or component 134.

In some examples, the component, when the first 130 and second aerofoils 131 are in the first position, comprises a substantially smooth aerofoil-like profile. By the first 130 and second aerofoils 131 combining to form a single component 134, the number of separated aerofoils 130,131 when in the first position is reduced relative to the number of separated aerofoils 130,131 within the OGV stage 128 when in the second position.

As shown in FIG. 5b, the sliding ring 142 may be axially displaced either of before, during or after a circumferential displacement between the first 130 and second aerofoils 131 as they are displaced from a first position towards a second position. In this way, a slot 156 provided in either or both of the inner outlet guide wall 132 and the sliding ring 142, along with a sliding member 157 arranged there between, is provided to allow axial displacement, labelled d3 in FIG. 5b, of the sliding ring 142 relative to the inner outlet guide wall 132. Thus, the slot provides a fulcrum arrangement for axial or circumferential displacement of the sliding member 157 relative to the slot. The sliding member 157 is arranged within the slot 156 in either or both of the inner outlet guide wall 132 and the sliding ring 142 so that it may either or both of axially and circumferentially displaced during circumferential displacement between the first 130 and second aerofoils 131. In some examples, the axial displacement between the inner outlet guide wall 132 and the sliding ring 142 can be increased or decreased by extracting and retracting the sliding member 157, relative to the slot 156.

When the first OGV 129a and the second OGV 129b are configured in a second position, shown in FIG. 5c, the inner outlet guide wall 132 and the inner sliding ring guide wall 144 have been relatively rotated from the first position towards the second position. Through relative rotation, relative displacement between the inner outlet guide wall 132 and the inner sliding ring guide wall 144 provides a circumferential displacement between the first aerofoil 130 and the second aerofoil 131. Thus, at least a portion of the pressure surface 135a the first aerofoil 130 is circumferentially displaced from at least a portion of the suction surface 136b of the second aerofoil 131. Thus, the first 130 and second aerofoils 131, when displaced towards the second position, separate to form two separate aerofoils or components 134. As shown in FIG. 5c, the sliding member 157 arranged between the inner outlet guide wall 132 and the sliding ring 142 has pivoted about angle α at a first and second fulcrum 158,159 during circumferential displacement between the first 130 and second aerofoils 131. Thus, angle α can be adjusted by circumferential displacement between the first 130 and second aerofoils 131.

In FIGS. 5a to 5c, either or both of the first 130 and second aerofoils 131 may be configured to pivot about a radial axis which is perpendicular to the axis 111 of rotation of the gas turbine engine 100. Thus, the camber of the first 130 and second aerofoils 131 may be varied according to requirements. In some examples, the camber of the first 130 and second aerofoils 131 may be varied to alter the aerodynamic profile of the respective aerofoils 130,131. In further examples, the camber of the first 130 and second aerofoils 131 may be varied to allow the first 130 and second aerofoils 131 to be combined in the first position. Adapting the camber of the aerofoils 130,131 aids in providing each aerofoil around the annulus with the equivalent, or identical loading.

Thus, in accordance with the examples shown in FIGS. 5a to 5c, when configured in the second position, the pressure profile of the second aerofoil 131 may be substantially identical to that of the first aerofoil 130. In this way, the first aerofoil 130 and the second aerofoil 131 may comprise an at least partially different aerodynamic profile. Thus, the first aerofoil 130 and the second aerofoil 131 may comprise alternate cross-sectional profiles, yet comprise an identical pressure distribution. Thus, it will be appreciated that the required similarities between the aerofoils are not necessarily linked to geometrical features. However, where the first aerofoil 130 and the second aerofoil 131 do comprise an at least partially different aerodynamic profile, thrust losses may be reduced by the first aerofoil 130 and the second aerofoil 131 maintaining an at least partially similar flow exit angle in order to avoid thrust losses in the bypass duct. In all examples however, the pressure profile distribution of the second aerofoil 131, in the second positon, is substantially identical to that of the first aerofoil 130. Thus, the arrangement provides a uniform pressure distribution across the whole annulus, at each radial position.

In some examples, the arrangement shown in FIGS. 5a to 5c does not comprise a slot 156 or sliding member 157. In further examples, the arrangement shown in FIGS. 5a to 5c does not allow axial displacement of the sliding ring 142 relative to the inner outlet guide wall 132. Thus, the second aerofoil 131 on the sliding ring 142 is provided with circumferential displacement, relative to the first aerofoil 130 on inner outlet guide wall 132, by the inner outlet guide wall 132 and the sliding ring 142 being relatively displaceable between a first axial position and a second axial position only.

FIGS. 3a to 5c show a plan view of the first 130 and second aerofoils 131, the inner outlet guide wall 132 and the sliding ring 142, so showing the inner annulus only. In some examples, the arrangements described in relation to the inner annulus may be replicated in the arrangements for the outer annulus. Alternatively, any one or more of the described arrangements may be used for the outer annulus in conjunction with the described arrangements for the inner annulus shown in FIGS. 3a to 5c.

In addition to the Figures shown, in further examples, the aerofoils may be provided in one or more segments. Each segment may comprise one or more aerofoils 130,131. Each segment may alternatively include two or more aerofoils 130,131. Such segments may be provided at one or more positions of the annular arrangement of the OGV stage 128. Thus, only a portion of the OGV stage 128 may comprise the described stator arrangement. Alternatively, two or more segments may be provided at two or more positions of the annular arrangement of the OGV stage 128. The segments may be equally spaced. The segments may be disparately spaced.

In further examples, the leading edge 137,139 of either or both of the first 130 and second aerofoils 131 may comprise a leading edge feature to re-energize the boundary layer and instigate a reattachment of the boundary layer on the respective aerofoil. The feature may comprise a slot or a slat. The feature may induce a disturbance in the flow over the leading edge 137,139 of either or both of the first 130 and second aerofoils 131.

In some examples, one or more of the first aerofoil 130, second aerofoil 131, inner outlet guide wall 132, outer outlet guide wall 133, and rings 142,151,152,153,154, according to FIGS. 3a to 5c, may be comprised of one or more metallic materials. Such metallic materials may comprise titanium. Such metallic materials may comprise a titanium alloy.

Such metallic materials may comprise nickel. Such metallic materials may comprise a nickel alloy. Such metallic materials may comprise a nickel-based super alloy. Such metallic materials may comprise an aluminium alloy. Such metallic materials may comprise a steel or an iron-based alloy.

In addition to the described structures or arrangements for rotating of one or more of the sliding rings 142,151,152,153,154, according to FIGS. 3a to 5c, relative to both the inner outlet guide wall 132 and the outer outlet guide wall 133, the sliding ring arrangement may further include a feedback or control device. The control device may control any positional change of one or more of the sliding rings 151,152,153,154 relative to both the inner outlet guide wall 132 and the outer outlet guide wall 133. Such control may be linked to a specific flight profile or operate according to an operational parameter or condition to provide autonomous operation. The setting of one or more of the sliding rings 151,152,153,154 may be completed prior to use, with a control loop to adapt the position of one or more of the sliding rings 151,152,153,154 relative to both the inner outlet guide wall 132 and the outer outlet guide wall 133 during use. Such use may refer to operational use during flight.

Additionally or alternatively, the trailing edge 138,140 of either or both of the first 130 and second aerofoils 131 may comprise a feature to modify the loading characteristics of the respective aerofoils and enhance their aerodynamic performance. The feature may comprise a flap or a protrusion. The trailing edge feature may change the loading of the respective aerofoils and enhance their aerodynamic performance.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A stator arrangement for use in a gas turbine engine, the arrangement comprising:
an inner outlet guide wall having a central axis, the inner outlet guide wall comprising a first aerofoil extending radially relative to the central axis;
an inner outlet guide wall further comprising a second aerofoil extending radially relative to the central axis, the second aerofoil being relatively displaceable between a first position and a second position;
the first aerofoil combining with the second aerofoil to form a combined aerofoil when the second aerofoil is in the first position, and separating to form two or more aerofoils when the second aerofoil is relatively displaced, in use, from the first position towards the second position;
wherein one or more of a profile, shape or configuration of the second aerofoil, when in the second position, are substantially identical to that of the first aerofoil.

2. A stator arrangement as claimed in claim 1, wherein a pressure profile of the second aerofoil, when in the second position, is substantially identical to that of the first aerofoil.

3. A stator arrangement as claimed in claim 1, wherein a cross-sectional profile of the second aerofoil, when in the second position, is substantially identical to that of the first aerofoil.

4. A stator arrangement as claimed in claim 1, the arrangement comprising an outer outlet guide wall configured around and radially displaced from the inner outlet guide wall.

5. A stator arrangement as claimed in claim 1, either or both of the first and second aerofoil extending between the inner outlet guide wall and the outer outlet guide wall.

6. A stator arrangement as claimed in claim 1, either or both of the inner outlet guide wall and outer outlet guide wall comprising two or more segments.

7. A stator arrangement as claimed in claim 1, the second aerofoil being relatively displaceable between a first position and a second position via a sliding ring, the sliding ring being slidably engaged with the inner outlet guide wall.

8. A stator arrangement as claimed in claim 1, the second aerofoil being relatively displaceable between a first position and a second position via a sliding ring, the sliding ring being slidably engaged with the outer outlet guide wall.

9. A stator arrangement as claimed in claim 1, the first aerofoil and the second aerofoil being relatively displaced between the first position and the second position when the first aerofoil and the second aerofoil are relatively rotated, in use, about the central axis.

10. A stator arrangement as claimed in claim 1, the first aerofoil and the second aerofoil being relatively displaced between the first position and the second position when the first aerofoil and the second aerofoil are circumferentially displaced, in use, about the central axis.

11. A stator arrangement as claimed in claim 1, a leading edge of the first aerofoil being axially displaced from a leading edge of the second aerofoil when displaced, in use, between the first position and the second position.

12. A stator arrangement as claimed in claim 1, at least a portion of the first aerofoil circumferentially aligning with at least a portion of the second aerofoil when in a first position.

13. A stator arrangement as claimed in claim 1, the first aerofoil being circumferentially adjacent to the second aerofoil when in a first position.

14. A stator arrangement as claimed in claim 1, the first aerofoil being axially adjacent to the second aerofoil when in a first position.

15. A stator arrangement as claimed in claim 1, either or both of the first aerofoil and second aerofoil being rotatable about an axis comprising a radial component relative to the central axis.

16. A stator arrangement as claimed in claim 1, wherein the stator arrangement is an outlet guide vane for incorporation within a gas turbine engine.

17. A stator arrangement as claimed in claim 1, the stator arrangement being incorporated within an outlet guide vane stage for incorporation within a gas turbine engine.

18. A stator arrangement for use in a gas turbine engine, the arrangement comprising:
an inner outlet guide wall having a central axis, the inner outlet guide wall comprising a first aerofoil extending radially relative to the central axis;
a sliding ring coaxially configured around the inner outlet guide wall, the sliding ring comprising a second aerofoil extending radially relative to the central axis, the inner outlet guide wall and the sliding ring being relatively displaceable between a first position and a second position;
the first aerofoil combining with the second aerofoil to form a combined aerofoil when the inner outlet guide wall and the sliding ring are in the first position, and separating to form two or more aerofoils when the inner outlet guide wall and the sliding ring are relatively displaced, in use, from the first position towards the second position;
wherein one or more of a profile, shape or configuration of the second aerofoil, when in the second position, are substantially identical to that of the first aerofoil.

19. A stator arrangement as claimed in claim 18, wherein a pressure profile of the second aerofoil, when in the second position, is substantially identical to that of the first aerofoil.

20. A stator arrangement as claimed in claim 18, wherein a cross-sectional profile of the second aerofoil, when in the second position, is substantially identical to that of the first aerofoil.
